(19) United States
(12) Patent Application Publication
(10) Pub. No.: US 2007/0041090 A1
(43) Pub. Date: Feb. 22, 2007

(54) Confocal laser scanning microscope

(76) Inventors: Dieter Gräfe, Jena (DE); Martin Kuhner, Bad Klosterlausnitz (DE); Frank Eismann, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/572,979

(22) PCT Filed: Sep. 15, 2004
(86) PCT No.: PCT/EP04/10344

§ 371 Date: Mar. 22, 2006

(30) Foreign Application Priority Data
Sep. 23, 2003 (DE) 10344060.7

(51) Int. Cl. G02B 21/00

(52) U.S. Cl. 359/371

(57) ABSTRACT

A confocal laser scanning microscope including an excitation beam path which focuses excitation radiation in a multiplicity of spots arranged in an object plane, and a detection beam path which confocally images the spots onto a multi-channel detector by means of pinhole stops, as well as a scanning unit which causes a two-dimensional relative movement between an object located in the object plane and the spots is described, wherein the scanning unit, during said relative movement, displaces the spots along a first direction and thus scans a strip of the object with the spots, and then displaces the spots along a second direction, in order to subsequently scan an adjacent strip by renewed displacement along said first direction.

The invention relates to a confocal laser scanning microscope, comprising an excitation beam path which focuses excitation radiation in a multiplicity of spots located in an object plane, and a detection beam path which confocally images the spots onto a multi-channel detector by means of pinhole stops, as well as a scanning unit which causes a two-dimensional relative movement between an object located in the object plane and the spots.

Laser scanning microscopy with simultaneous scanning of several spots enables accelerated scanning of an object. U.S. Pat. No. 6,262,423 describes a confocal laser scanning microscope of the type mentioned above, wherein a microlens array located on a Nipkow disk is illuminated by an expanded laser beam. The spots of the partial beams generated by the lens array are imaged into the object plane by a micro-objective, and fluorescence radiation emitted by the spots is picked up by the micro-objective and guided to a CCD receiver via a beam splitter. By one rotation of the Nipkow disk, the CCD area sensor is illuminated in a point-wise manner and thus picks up the complete image signal. With approximately a hundred individual lenses on the disk, a very quick object scanning is possible. The resolution is predetermined by the pixel number and pixel size of the CCD area sensor and is invariable. Also, it is technologically complex and, thus, expensive to produced the Nipkow disks with exactly positioned microlenses applied thereon.

A further confocal laser scanning microscope of the above-mentioned type is known from U.S. Pat. No. 6,028,306. In the device described therein, a spot distribution comprising several spots is imaged into an object plane using a laser light source and a microlens array. The spots are confocally imaged by means of a stop array. An x/y beam scanner scans the surface to be examined, with the spots being displaced in one embodiment over a path length which is as great as the distance between adjacent spots. This allows a large surface area to be scanned using a small beam deflection, because each of the adjacent individual spots scans a small region and all these regions together fill the scanned surface. A disadvantage of this arrangement is that the small scanned regions of the individual spots have to abut against each other seamlessly with tolerances in the micrometer range. In some applications, radiation cross-talk would cause effects of bleaching and saturation of fluorophores, which cannot be compensated.

It is an object of the invention to provide a laser scanning microscope of the above-mentioned type, which allows quick scanning of an object.

In a confocal laser scanning microscope, comprising an excitation beam path which focuses excitation radiation in a multiplicity of spots arranged in an object plane, and a detection beam path which confocally images the spots onto a multi-channel detector by means of pinhole stops, as well as a scanning unit which causes a two-dimensional relative movement between an object located in the object plane 11 and the spots, this object is achieved in that the scanning unit, during said relative movement, displaces the spots along a first direction and thus scans a strip of the object with the spots, and then displaces the spots along a second direction, in order to subsequently scan an adjacent strip by renewed displacement along said first direction.

Thus, according to the invention, the object is scanned in strips, each strip being sensed by guiding all spots across it. In contrast to U.S. Pat. No. 6,028,306 mentioned above, the object surface to be sensed is thus not divided into individual single spot regions, which are to be seamlessly joined with each other and which are each sensed by a single spot, but all spots together detect fluorescence radiation from the strip. By a subsequent displacement of the spots in a second direction, which is preferably orthogonal to the first direction, the next strip of the object is imaged. The object surface is thus divided into strips, with all spots being guided over each strip.

The generation of the spot pattern is conveniently effected by means of microlens array arranged in the excitation beam path and not used for detection, which microlens array causes a line-shaped or rectangular or square shaped arrangement of the spots. The pinhole stops are, of course, adapted to the spot pattern; for a line-shaped microlens array, a line of stops will be used; for a rectangular or square spot pattern, a corresponding stop array is provided. Advantageously, the pinhole stops are not located in the excitation beam path, but are arranged, for example, preceding the multi-channel detector, because there will then be no interfering reflections of excitation radiation. Thus, separate diffraction-limiting objects are provided in order to generate and detect the spots, and a central stop unit which is part of both the excitation and the detection beam paths can be omitted.

In order to prevent cross-talk between adjacent spots, it is convenient to set a large distance, with respect to the spot diameter, between adjacent spots. This distance should preferably be at least ten times the spot diameter.

A great distance between adjacent spots is particularly easy to realize for the scanning effected by the microscope according to the invention, if the spot pattern is tilted relative to the first direction such that the spots have a distance, perpendicular to said direction, of equal to or less than the spot diameter. On the one hand, this embodiment ensures that the strip of the object is continuously scanned by all spots during displacement along the first direction and that, on the other hand, a distance of almost any size can be set between adjacent spots.

The tilting or oblique positioning of the spot pattern relative to the first direction with which the scanning unit relatively moves the beam may be achieved in an optical scanning unit in that the element generating the optical spots in the excitation beam path, e.g. the aforementioned microlens array, is rotated about the optical axis in the beam path relative to the first direction, as are the pinhole stops and the multi-channel detector.

Particularly preferably, the microscope according to the invention uses a path of displacement along the first direction to be considerably longer than the distance between adjacent spots, so that the problem mentioned with respect to U.S. Pat. No. 6,028,306, namely that small regions have to be seamlessly joined, is avoided.

The invention will be explained in more detail below, by way of example and with reference to the Figures, wherein:

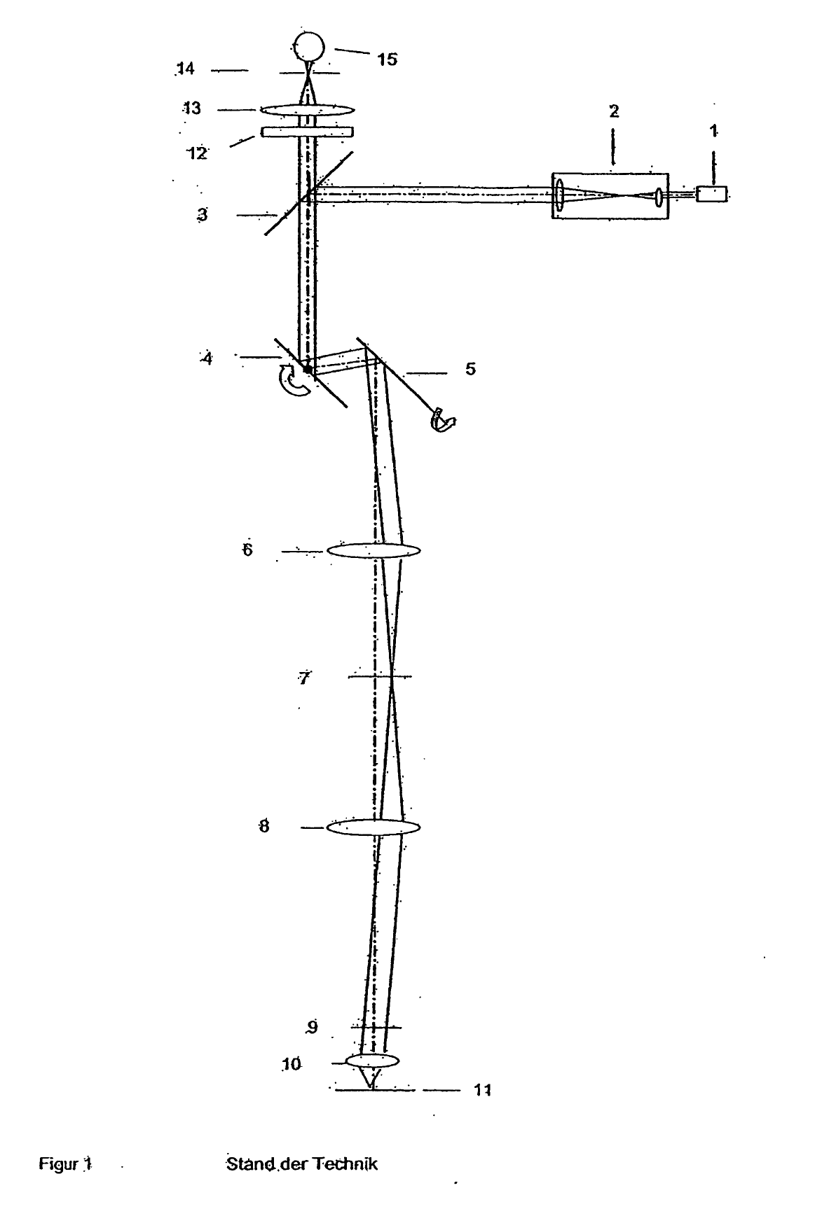

FIG. 1 shows a conventional laser scanning microscope which scans an object with a beam;

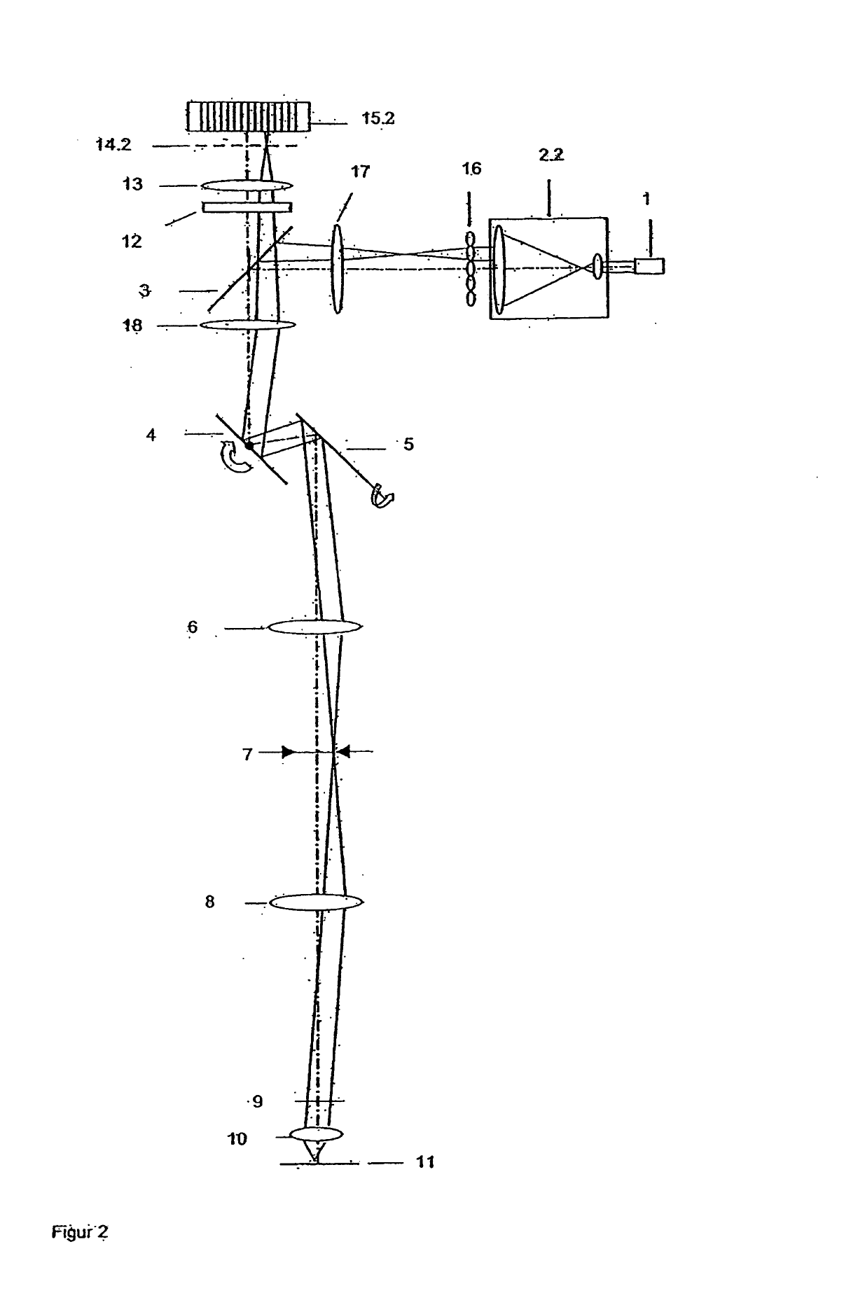

FIG. 2 shows a laser scanning microscope according to the invention which scans an object with several beams;

FIG. 3 shows a schematic representation of the spot distribution and scanning movement for a spot line;

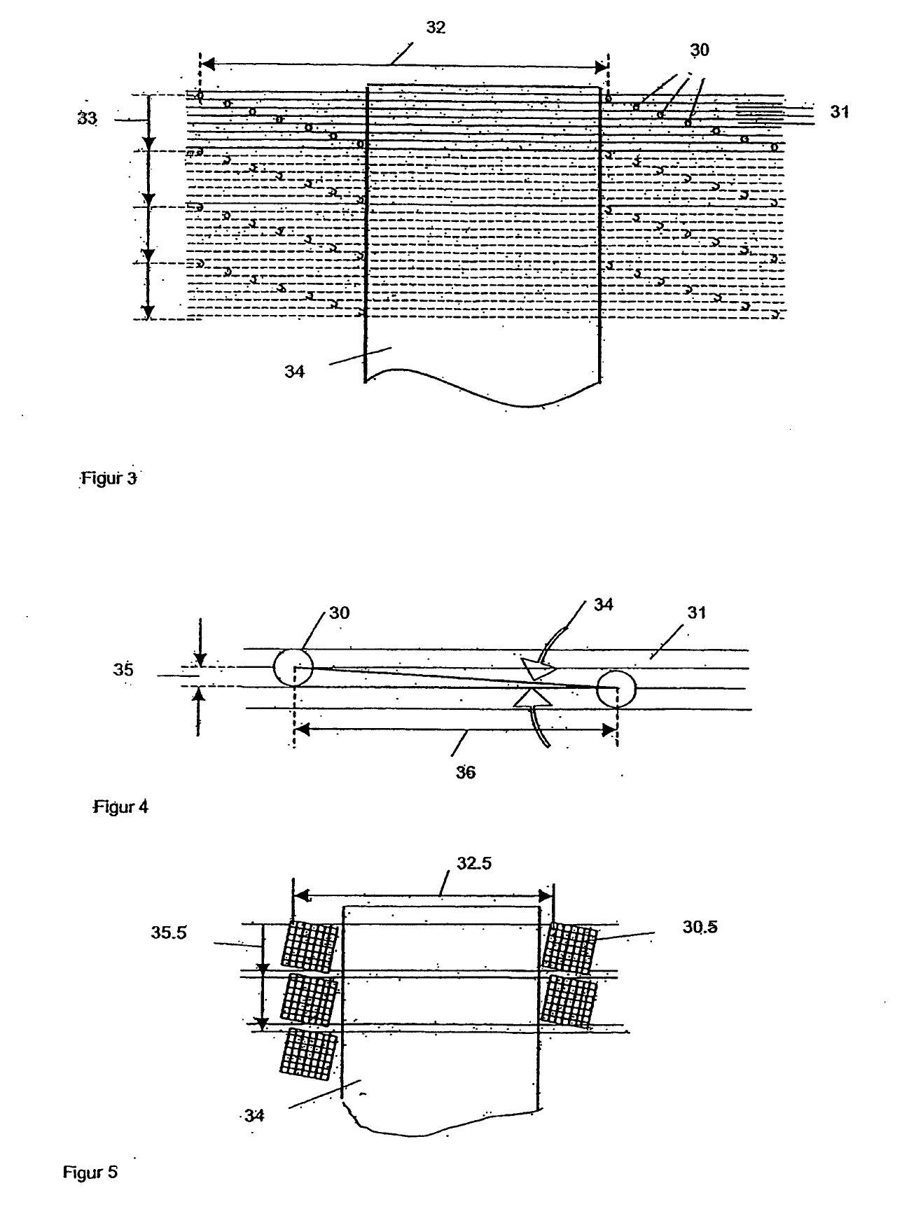

FIG. 4 shows a schematic representation of the position of adjacent spots relative to one another;

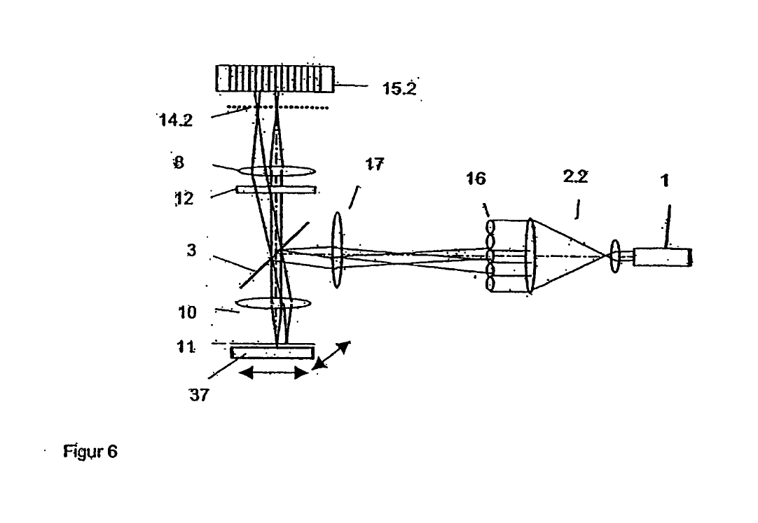

FIG. 5 shows a scanning movement for a square spot distribution;

FIG. 6 shows a laser scanning microscope similar to that of FIG. 2, but with a table top scanning unit.

FIG. 1 shows a conventional laser scanning microscope comprising an optical beam scanner, with an object being scanned by a beam. The radiation of a laser 1 is adapted with respect to the beam parameters, such as waist position and beam cross-section, to the requirements of the microscope by an optical arrangement 2. The excitation or illumination radiation is coupled into the main beam path by a splitter 3 and guided onto beam scanners 4 and 5. The beam scanners are arranged closely adjacent to each other and in the immediate vicinity of a pupil of the beam path. As shown in the Figure, they have axes of rotation, which are perpendicular to each other, and can be separately controlled.

Subsequently arranged scanning optics 6 generate a spot image in an image plane 7 for all different beam deflections generated by the scanners. A tube lens 8 collects the radiation in an aperture plane 9, starting from which an objective 10 generates a spot image reduced in size in an object plane 11.

In the case of a fluorescence excitation parts of the sample emit at each spot fluorescence radiation with radiation that is displaced to longer wavelengths relative to the excitation radiation. This radiation is collected again by the objective 10 and travels back the same way through the described set-up.

Due to the double pass through the beam scanners 4 and 5, the detected beam movement after the scanner is neutralized, and a resting beam of radiation is obtained once more.

The beam splitter 3 causes a separation of the fluorescence radiation into a detection beam path. An interference filter 12 separates components of the shorter wavelengths excitation radiation which might be still present in the beam path.

In a pinhole plane 13, a lens 13 generates a spot image of the just illuminated and fluorescent object point in the object plane 11. A detector 15, in this case a single-point receiver, which is arranged following the pinhole plane 13, provides a radiation intensity-dependent video signal, which is converted to an image signal by a connected evaluating unit. In arrangements for structural examination, radiation reflected by the object 11 is picked up, and the splitter 3 is not a wavelenght-selective, dichroic beam splitter, but a simple, neutral beam splitter. The emission filter 12 can then be omitted. The size of the pinhole stop allows to set the size of the object structure to be detected, and decreasing stop diameters provide a higher depth discrimination in the object plane, i.e. the stop diameter set the depth region from which the radiation for image generation is taken. Interfering radiation components from other depth regions are thus eliminated. This is the decisive advantage of laser scanning microscopy over conventional light microscopy.

FIG. 2 shows a confocal multichannel laser scanning microscope, which corresponds to the construction of FIG. 1, except for the modifications described in the following. The arrangement is equipped for multichannel operation. For this purpose, a collimated laser beam is suitably expanded by a telescope 2.2 such that it illuminates a lens array 16 as completely and uniformly as possible. The geometry of the lens array 16 and the number and distribution of its channels depend on the detector array employed, e.g. a corresponding Multianode Photomultiplier Tube of the Hamamatsu corporation, such as type H7546 with 8×8 individual receivers or H7260 or a linearly arranged detector array comprising 1×32 individual receivers. In the first case, a lens array (square arrangement) comprising 8×8 microlenses is required; in the second case, a linear array (line) comprising 32 microlenses in a row is required. The individual lenses of the lens arrays 16 have a sufficiently uniform focal length, which is the case, for example, when manufacture is effected by a lithographic method.

The expansion optics 2.2 for the laser beam are suitably dimensioned for illumination of the respective lens array 16. In this respect, the homogeneity of the illumination is to be obeyed. Alternatively, corresponding holographic optical elements (HOE) can be used to improve illumination.

The expanded and collimated beam is split by the lens array 16 into a plurality of partial beams. A lens system 17 and 18, whose function can also be realized by a single lens, transforms the thus formed individual spots into a common aperture image, which is advantageously located between the closely adjacent beam scanners 4 and 5. Fan-shape collimated ray bundles, one bundle each for each spot, are emitted by the aperture image. The mirror size of the scanners is dimensioned such that they cover all ray bundles even in the fully deflected condition. Scanning optics pick up the ray bundles and generate a spot distribution, i.e. an arrangement of several individual spots, which moves with the scanner movement in an image plane 7. Preferably, fixed or adjustable stop arrangement 7 is arranged in the image plane 7, said arrangement precisely marking the area to be scanned, so that spots which are, due to the regime of measurement, located outside the desired image region do not reach the object field and cannot cause fluorescence bleaching, fluorescence saturation or other irreversible changes in the sample.

The spot distribution, reduced in size, is imaged into the object plane 11 by a tube lens 8 and an objective 10. The fluorescent structure or sample located in the object plane is excited by the moving spot distribution to emit fluorescence radiation usually of longer wavelengths. This radiation travels the same path as the excitation radiation back through the optical arrangement up to the main color splitter. By the two-time passage over the scanners, the beam movement is, thus, descanned, i.e. neutralized, so that a resting beam is formed in the portion between the scanner 4 and the detector, which is now provided as a detector array 15.2.

The dichroic beam splitter 3 separates the detection beam path from the excitation beam path, with an emission filter 12 blocking reflected residues of the excitation light. A lens system 18 and 13 provides for focusing into a further image plane being located immediately in front of the detector array 15.2. A confocal pinhole array 14.2 is located in this image plane. It is adjusted to the position of the spot distribution generated by the lens array 16 and acts analog to the pinhole stop 14 and separates light from different depth levels of the sample attached to the object plane 11. The individual channels of the detector array 15.2 provide, simultaneously associated with each spot, coupled with the scanner movement, time varying signals which are combined by electronic evaluation to form an image.

FIG. 3 shows the spot distribution for a linear (line) arrangement of the lens array 16, the detector array 15.2 and the pinhole array 14.2. It shows the scanning operation over an area 34 to be scanned. The starting point for the scanning operation is, for example, a position of a tilted row of spots to the right of the area 34. As scanning starts, the first scanner moves the row of spots along a direction 32 and displaces the spots 30 over a strip of the object field. After this, the second scanner becomes active and displaces all spots 30 along direction 33. Next, the first scanner moves back in the direction 32, an a second adjacent strip is imaged. This is continued so as to scan the entire area. Each spot 30 thus moves on a path 31 and all paths 31 jointly cover a strip. The scanning length in the direction 32 is determined by the length of the area, enlarged by the length of the spot distribution along the direction 32. For clarity, the row of spots is shown substantially longer than the corresponding dimensions of the area 34.

Assuming a spot diameter of 1 μm and 10 individual spots, the length of the row of spots for a spot distance of 10 times greater than the diameter is 100 μm. Using a stop 7 in the image plane, lateral areas next to the area 34 can be protected against illumination.

As shown in more detail in FIG. 4, the spots 30 are located on a straight line 34 which is inclined with respect to the direction 32 or the paths 31, respectively. The spot radius 35 is dimensioned to match the resolution of the objective 10. For a given wavelength and a diffraction-limited optical design, said resolution is determined only be the reciprocal numerical aperture. In order to fully use the resolution by the scanning operation, the spots 30 have a distance 36 in the projection perpendicular to the scanning direction 32 or path 31 which distance is equal to or smaller than the size of a spot radius 35. The distance 36 is determined by the cross-talk between adjacent spots 30 and is calculated from the image function (point spread function PSF). The angle of inclination 34 to be set according to FIG. 3 corresponds to arctan (spot radius/spot distance). For a spot distance equal ten-times the spot diameter, arctan ( 1/20)=2.860. The lens array 16 is set up tilted about this angle relative to the direction 32 or path 31.

FIG. 5 shows the scanning movements 32.5 and 33.5 for a square spot array. The spot array 30.5 is not shown in detail in the illustration. Here, the indicated inclination is also set between the individual spots, which is now expressed as an array inclination, and the inclined image is scanned over the sample area 34.

FIG. 6 shows an arrangement with an x/y table scanner. The optical structure is analog to a light microscope here. The image of the spot distribution is generated in the image plane located in front of the receiver 15.2, in which plane the confocal pinhole array 14.2 is arranged. The sample is displaced by the x/y scanning table in the indicated directions, analog to 32 and 33 or 32.5 and 33.5, respectively, in FIGS. 3 and 5. For high spot numbers, for which scanning has to be effected at low speeds due to the limited light power available, such an arrangement is advantageous in order to quickly sense even larger sample areas 34.

1-5. (canceled)

6. A confocal laser scanning microscope, comprising:
an excitation beam path which focuses excitation radiation in a multiplicity of spots arranged in an object plane, each spot having a diameter and a radius;
a detection beam path which confocally images the spots onto a multi-channel detector by pinhole stops; and
a scanning unit which causes a two-dimensional relative movement between an object located in the object plane and the spots;
wherein the scanning unit, during said relative movement, displaces the spots along a first direction and thus scans a strip of the object with the spots, and then displaces the spots along a second direction to subsequently scan an adjacent strip by renewed displacement along said first direction.

7. The microscope as claimed in claim 6, further comprising a microlens array for focusing the excitation radiation, the microlens array comprising microlenses in a line-shaped or rectangular arrangement, which cause a line-shaped or rectangular spot pattern.

8. The microscope as claimed in claim 7, wherein the spot pattern is tilted with respect to the first direction such that the spots are spaced from each other, substantially perpendicular to the first direction, by a distance substantially equal to or smaller than the spot diameter.

9. The microscope as claimed in claim 7, wherein the spot pattern is tilted with respect to the first direction such that the spots are spaced from each other, substantially perpendicular to the first direction, by a distance substantially equal to or smaller than the spot radius.

10. The microscope as claimed in claim 8, wherein the distance between adjacent spots in the object plane is equal to at least about ten times the spot diameter.

11. The microscope as claimed in claim 8, wherein a path of the displacement along the first direction is greater than the distance between adjacent spots.

12. A method of confocal laser scanning microscopy, comprising:
focusing an excitation beam through an excitation beam path which focuses excitation radiation in a multiplicity of spots arranged in an object plane, each spot having a diameter and a radius;
receiving emitted radiation via a detection beam path which confocally images the spots onto a multi-channel detector by pinhole stops; and
scanning the multiplicity of spots via a scanning unit which causes a two-dimensional relative movement between an object located in the object plane and the spots;
displacing the spots along a first direction and thus scanning a strip of the object with the spots, and then displacing the spots along a second direction to subsequently scan an adjacent strip by renewed displacement along said first direction.

13. The method as claimed in claim 12, further comprising utilizing a microlens array for focusing the excitation radiation, the microlens array comprising microlenses in a line-shaped or rectangular arrangement, which cause a line-shaped or rectangular spot pattern.

14. The method as claimed in claim 13, further comprising tilting the spot pattern with respect to the first direction such that the spots are spaced from each other, substantially perpendicular to the first direction, by a distance substantially equal to or smaller than the spot diameter.

15. The method as claimed in claim 13, further comprising tilting the spot pattern with respect to the first direction such that the spots are spaced from each other, substantially perpendicular to the first direction, by a distance substantially equal to or smaller than the spot radius.

16. The method as claimed in claim 14, further comprising setting the distance between adjacent spots in the object plane equal to at least about ten times the spot diameter.

17. The method as claimed in claim 15, further comprising setting a path of the displacement along the first direction to be greater than the distance between adjacent spots.
